(19) United States
(12) Patent Application Publication
(10) Pub. No.: US 2015/0024106 A1
(43) Pub. Date: Jan. 22, 2015

(54) pH-adjusted sweetener

(71) Applicants: Thomas Hüller, Marl (DE); Juergen Haberland, Haltern am See (DE); Olivier Zehnacker, Dortmund (DE); Karl Ludovici, Bergisch Gladbach (DE); Gerda Oswald, Erftstadt (DE); Ulrich Bongers, Kerpen (DE)

(72) Inventors: Thomas Hüller, Marl (DE); Juergen Haberland, Haltern am See (DE); Olivier Zehnacker, Dortmund (DE); Karl Ludovici, Bergisch Gladbach (DE); Gerda Oswald, Erftstadt (DE); Ulrich Bongers, Kerpen (DE)

(73) Assignee: Evonik Degussa GmbH, Essen (DE)

(21) Appl. No.: 14/378,565

(22) PCT Filed: Feb. 12, 2013
(86) PCT No.: PCT/EP2013/052759

§ 371 Date: Aug. 13, 2014

(30) Foreign Application Priority Data
Feb. 14, 2012 (DE) 10 2012 202 193.0

(51) Int. Cl. A23G 3/38

(52) U.S. Cl. CPC A23G 3/38
USPC 426/548

(57) ABSTRACT

The invention relates to processes for producing hard sweets from isomalt while maintaining strict pHs, and also to mixed compositions containing isomalt and optionally pH buffer substances having a defined pH.

### FIELD OF THE INVENTION

The invention relates to processes for producing hard sweets from isomalt while maintaining strict pHs, and also to mixed compositions containing isomalt and optionally pH buffer substances having a defined pH.

### PRIOR ART

Isomalt is included in the group of disaccharide alcohols and is used as a sugar replacer. The conventional production proceeds in two process steps: Enzymatic isomerization of sucrose to isomaltulose and hydrogenation of the isomaltulose to isomalt. The product isomalt is a mixture of isomers of 1-O-α-D-glucopyranosyl-D-mannitol (1,1-GPM) and 6-O-α-D-glucopyranosyl-D-sorbitol (1,6-GPS) (see also: J. Kowalczyk., Isomalt, pp. 340-359 in K. Rosenplenter, U. Nöhle (editors), Handbuch der Süβungsmittel [Handbook of Sweeteners], 2007, B. Behr's Verlag GmbH & Co. KG).

Classical hard sweets are confectionaries substantially consisting of sucrose and glucose which are produced with the use of substances giving aroma and taste, colour, and influencing properties. Hard sweets have a hard, glassy consistency.

Isomalt, on account of its low calorie content, good heat stability and the inert properties thereof in combination with other ingredients used in hard sweet production, can be used as a direct replacement of sucrose for “sugar-free” hard sweets (H. Schiweck, et al. (2005) Sugar Alcohols, in Ullmann's Encyclopedia of Industrial Chemistry, Wiley-VCH).

Hard sweets are now usually produced by processes in which the sugar or the sugar replacer is first dissolved as granules with water. Then, the mass is reduced by a water content of 2% in a boiling process under vacuum and cooled, in such a manner that the mass can be admixed with corresponding additives (flavours, acids, colours). The hard sweet mass is then stamped or cast into the desired mould.

An alternative process is the injection moulding process, in which the sugar granules or sugar replacer granules are processed directly without the detour via the aqueous solution. The raw material is plasticized in an injection moulding machine in a picklable cavity and thermally and materially homogenized. After cooling to demoulding temperature, the moulded piece can be removed.

With the increasing nutritional consciousness of consumers, the demand for sugar-free and reduced-calorie confectionaries is constantly increasing. Therefore, in recent years, hard sweets based on isomalt have been increasingly offered.

Processes for producing hard sweets based on isomalt are described in the prior art: EP1217898 discloses a hard sweet containing 1,1-GPM (1-O-alpha-D-glucopyranosyl-D-mannitol) in an amount of 52 to 60% by weight (based on total dry matter of the hard sweet) and sorbitol in an amount of 0.5 to 3.5% by weight, and a process for producing a hard sweet, wherein an aqueous solution or suspension of a mixture containing 52 to 60% by weight of 1,1-GPM and 0.5 to 3.5% by weight of sorbitol is evaporated under the action of heat, cooled, moulded, and a hard sweet is obtained.

WO01/03513 describes a process for producing a sugar-free, non-cariogenic, hard confectionary, which comprises the following steps:
a) production of a syrup (1) having a dry matter content of 60 to 80%, consisting of a mixture of hydrogenated starch hydrolysate syrup (2) and isomalt powder or isomalt syrup (3), characterized in that the dry matter of the syrup (1) consists of 14 to 25% w/w of hydrogenated starch hydrolysate syrup (2) (dry matter), wherein the dry matter of the hydrogenated starch hydrolysate syrup (2), comprises between 22 and 55% w/w of higher polyols, and the dry matter of the syrup (1) consists of 75 to 86% w/w of isomalt, and the dry matter of the syrup (1) consists of 7 to 52% w/w of 6-O-α-D-glucopyranosyl-D-sorbitol (1,6 GPS), 24.5 to 52% w/w of 1-O-α-D-glucopyranosyl-D-mannitol (1,1 GPM), 0 to 52% w/w of 1-O-α-glucopyranosyl-D-sorbitol (1,1 GPS), 0 to 1.3% w/w of sorbitol (DP1), 2.8 to 13.8% w/w of maltitol (DP2), 1.5 to 4.2% w/w of maltotriitol (DP3), 3.0 to 13.5% w/w of higher polyols (DPn),
b) boiling at a temperature between 145 and 170° C. and a slight vacuum, and
c) shaping by the stamping or depositing method.

In practice, it has been found that conventional isomalt, for reasons that have not been clarified to date, in the standard processes has a tendency to cloudy freezing, and therefore to the formation of opaque hard sweets. In addition, in some batches an increased hygroscopicity of the hard sweets may be recorded, which leads to sticky hard sweets after a short storage time. These adverse product properties are reduced batchwise in the industrial production process by the means that, in the process for isomalt hard sweets, only demineralized water is used. The use of this pretreated water, in comparison with conventional processes using sugar is an unnecessary expenditure, since there the already available tapwater is employed. Because transparency, colourlessness and stickiness of a hard sweet is a clear and obvious feature of product quality, it is desirable to provide a process which yields solely high-quality hard sweets based on isomalt.

It was therefore the object of the invention to provide a process which reliably and faultlessly delivers solely high-quality, isomalt-based hard sweets.

### DESCRIPTION OF THE INVENTION

Surprisingly, it has been found that the processes described hereinafter for producing isomalt-based hard sweets, in which the isomalt is present in an environment having a defined pH range, and mixed compositions containing isomalt and pH buffer substances are able to achieve the object posed by the invention.

The present invention therefore relates to aqueous isomalt solutions having a defined pH, mixed compositions containing isomalt and defined pH buffer substances.

The invention further relates to a process for producing isomalt-based hard sweets, in which the aqueous isomalt solution has a defined pH range.

The invention further relates to a process for producing isomalt-based hard sweets, in which solid mixed compositions containing isomalt and defined pH buffer substances are melted and plasticized.

One advantage of the present invention is that via the controlled pH guidance in the course of the process, isomalt-based hard sweets having a low hygroscopicity and without increased colour values may be produced reproducibly.

A further advantage of the present invention is that clear hard sweets may be prepared reproducibly.

A further advantage of the present invention is that hard sweets may be prepared which have a low, and therefore good, recrystallization tendency.

One advantage of the mixed composition according to the invention is the homogeneous fusibility thereof.

A further advantage of the mixed composition according to the invention is the capacity thereof to preserve dyes in a stable manner in the hard sweet.

A further advantage is that the mixed composition according to the invention has good flowability.

A further advantage of the mixed composition according to the invention is the good compactibility thereof.

A further advantage of the solid mixed composition according to the invention is the good demoulding behaviour thereof.

The “pH” in the context of the present invention is defined as the value which is measured using a calibrated pH electrode as specified in ISO 4319 (1977) for corresponding compounds dissolved in demineralized water at 25° C. after stirring for five minutes. The expression “aqueous solution” in the context of the present invention is taken to mean at least one corresponding substance at least partly dissolved in water, wherein the solution preferably contains at least 5% by weight of water, based on the total composition considered.

The “buffering” capacity in the context of the present invention is defined as that a value of “1” corresponds to a buffer solution the pH of which changes by 1 pH unit on addition of 1 mol of base per litre of buffer solution, under conditions as described above for the pH measurement.

The present invention therefore relates to
an aqueous solution containing
20% by weight to 75% by weight, preferably 40% by weight to 65% by weight, particularly preferably 45% by weight to 60% by weight, of 6-O-α-D-glucopyranosyl-D-sorbitol,
25% by weight to 80% by weight, preferably 35% by weight to 60% by weight, particularly preferably 40% by weight to 55% by weight, of 1-O-α-D-glucopyranosyl-D-mannitol,
wherein the percentages by weight relate to the total amount of the sugars and sugar alcohols of the total solution, characterized in that the solution, at a temperature of 25° C., has a pH of 4.0 to 5.0, preferably 4.1 to 4.5, particularly preferably 4.2 to 4.3.

Since there are various quality grades of isomalt which, depending on the production process, can contain further products, in addition aqueous solutions are claimed, additionally containing, 0.02% by weight to 15% by weight, preferably 0.1% by weight to 10% by weight, particularly preferably 0.2% by weight to 5% by weight, of 1-O-α-D-glucopyranosyl-D-sorbitol,
0.02% by weight to 15% by weight, preferably 0.1% by weight to 8% by weight, particularly preferably 0.2% by weight to 3.5% by weight, of sorbitol and
0.02% by weight to 15% by weight, preferably 0.1% by weight to 10% by weight, particularly preferably 0.2% by weight to 2.9% by weight, of mannitol,
wherein the percentages by weight relate to the total amount of the sugars and sugar alcohols of the total solution.

Solutions preferred according to the invention have a total amount of sugars and sugar alcohols of 40% by weight to 90% by weight, preferably 70% by weight to 80% by weight, based on the total aqueous solution.

It is known to those skilled in the art how the pH of an aqueous solution can be influenced; for instance, it can be elevated or lowered by adding bases or acids. In particular, aqueous solutions of alkali metal hydroxides such as, for example, NaOH (aq) are suitable as bases; suitable acids are, for example, mineral acids such as, for example, HCl, or organic acids, such as acetic acid, for example.

In addition, a mixed composition is claimed containing, preferably consisting of,
20% by weight to 75% by weight, preferably 40% by weight to 65% by weight, particularly preferably 45% by weight to 60% by weight, of 6-O-α-D-glucopyranosyl-D-sorbitol,
25% by weight to 80% by weight, preferably 35% by weight to 60% by weight, particularly preferably 40% by weight to 55% by weight, of 1-O-α-D-glucopyranosyl-D-mannitol, and
0.02% by weight to 15% by weight, preferably 0.5% by weight to 5% by weight, particularly preferably 0.5% by weight to 2% by weight, of pH buffer substance,
wherein the percentages by weight relate to the total amount of the sugars and sugar alcohols of the total mixed composition, characterized
in that it has, in the form of a 40% by weight dry matter-containing aqueous solution, wherein the percentages by weight relate to the total aqueous solution, at a temperature of 25° C., a pH of 4.0 to 5.0, preferably 4.1 to 4.5, particularly preferably 4.2 to 4.3.

The expression “pH buffer substance” is taken to mean one or more chemical compounds which are able to keep the pH of an aqueous solution constant on account of a reaction trapping hydrogen or hydroxide ions with the formation of weak acids or bases, on the basis of the dissociation equilibrium.

All of the percentages (%) cited are, unless stated otherwise, percent by mass.

Since there are various quality grades of isomalt which, depending on the production process, can contain further products, in addition mixed compositions are claimed, additionally containing
0.02% by weight to 15% by weight, preferably 0.1% by weight to 10% by weight, particularly preferably 0.2% by weight to 5% by weight, of 1-O-α-D-glucopyranosyl-D-sorbitol,
0.02% by weight to 15% by weight, preferably 0.1% by weight to 8% by weight, particularly preferably 0.2% by weight to 3.5% by weight, of sorbitol and
0.02% by weight to 15% by weight, preferably 0.1% by weight to 10% by weight, particularly preferably 0.2% by weight to 2.9% by weight, of mannitol,
wherein the percentages by weight relate to the total amount of the sugars and sugar alcohols of the total mixed composition.

These additional components can advantageously affect the properties of the hard sweets with respect to their glass transition temperature and compactibility.

In particular, mixed compositions preferred according to the invention, at a temperature of 25° C., in the form of a 40% by weight dry matter-containing aqueous solution, wherein the percentages by weight relate to the total aqueous solution, at a temperature of 25° C. and a pH of 4.2, have a buffering capacity of at least 0.01 mmol/l, in particular of at least 0.05 mmol/l, particularly preferably of at least 0.1 mmol/l.

Mixed compositions preferred according to the invention are characterized in that they contain a pH buffer substance which, at a temperature of 25° C., has a buffer maximum in a range from pH 4.0 to 5.0.

pH buffer substances particularly preferably contained according to the invention are selected from the group comprising, preferably consisting of:

Citrate buffer, acetate buffer, citrate-phosphate buffer.

A mixed composition particularly preferred according to the invention contains, as pH buffer substance, acetate buffer, wherein this contains 0.12% by weight of glacial acetic acid and 0.08% by weight of sodium-acetate trihydrate, wherein the percentages by weight relate to the dry matter of the total mixed composition.

A mixed composition particularly preferred according to the invention contains, as pH buffer substance, citrate buffer, wherein this contains 0.30% by weight of citric acid and 0.31% by weight of sodium-citrate, wherein the percentages by weight relate to the dry matter of the total mixed composition.

In a preferred embodiment, the mixed compositions according to the invention are characterized in that they are solid, preferably crystalline, at 25° C.

Said mixed compositions may be advantageously used in the injection moulding process.

Preferably, said mixed compositions have a cylindrical or lens-shaped granule shape. Solid mixed compositions preferred according to the invention are characterized in that they have a water content of less than 2% by weight, preferably less than 1.5% by weight, in particular less than 0.5% by weight, based on the total mixed composition.

In a preferred alternative embodiment, the mixed compositions according to the invention are in the form of aqueous solutions which may advantageously be used for producing hard sweets in the classic method.

This subject matter of the present invention is depicted by an aqueous solution containing 40% by weight to 90% by weight, preferably 70% by weight to 80% by weight, of a mixed composition according to the invention, wherein the percentages by weight cite the amount of dry matter, based on the total aqueous solution.

Preferred aqueous solutions according to the invention have a pH of 4.0 to 5.0, preferably 4.1 to 4.5, particularly preferably 4.2 to 4.3, at a temperature of 25° C.

A further subject matter of the present invention is the use of aqueous solutions or mixed compositions according to the invention for producing hard sweets.

The present invention further relates to a first process for producing a hard sweet, comprising the process steps
A) providing a mixed composition according to the invention in the form of a 40% by weight to 90% by weight, preferably 70% by weight to 80% by weight, aqueous solution, wherein the percentages by weight cite the amount of dry matter, based on the total aqueous solution,
B) heating the aqueous mixed composition and reducing the water content to less than 2% by weight, preferably less than 1.5% by weight, in particular less than 0.5% by weight, based on the total mixed composition,
C) cooling the mixed composition to a temperature of 100° C. to 130° C., in particular 110° C. to 120° C., and optionally adding further additives such as, for example, flavours, colours and acids, and optionally homogenizing, and
D) shaping and further cooling the mixed composition to give the desired hard sweet.

It is advantageous to completely dissolve all components of the mixed composition in process step A) in order to avoid uncontrolled recrystallization during the production process. This can preferably be achieved by a higher temperature during the dissolution operation, in such a manner that here the aqueous solution is heated in the process step A), preferably to 70° C. to 100° C., in particular 80° C. to 90° C.

Process step B) can be carried out on all familiar types of batch cookers, semicontinuous and continuous cooking systems. For the ideal setting of the cooking operation and subsequent measurement of the water content, it must be noted that the cooking curves are system-specific and are therefore only convertible with restrictions. In order to achieve good storage stability, the melt should preferably be boiled down to a water content of less than 5, in particular less than 2, percent. For this purpose, generally, temperatures are used between 135° C. and 185° C., preferably from 145° C. to 175° C., in particular 155° C. to 165° C.

It is preferred according to the invention if process step B) is carried out under vacuum, in particular at 0.05 bar to 0.2 bar.

In the case of continuous cooker systems, for example coil cookers, the discharge devices such as rollers or screws should not be heated excessively. A lower temperature increases the adhesion of the mass and thus ensures constant discharge. Incorporation of further ingredients into process step C) such as flavourings, sweeteners, acid or else minerals, can proceed via a mixing device in the continuous process. Since some flavourings are temperature-sensitive, and rapidly volatilize at relatively high temperatures, the mass must be cooled in advance in semicontinuous or batchwise production.

The present invention further relates to a second process for producing a hard sweet, comprising the process steps
A) providing an aqueous solution containing
20% by weight to 75% by weight of 6-O-α-D-glucopyranosyl-D-sorbitol,
25% by weight to 80% by weight of 1-O-α-D-glucopyranosyl-D-mannitol % by weight, optionally
0.02% by weight to 15% by weight of a-D-glucopyranosyl-1,1-D-sorbitol, optionally
0.02% by weight to 15% by weight of sorbitol and optionally
0.02% by weight to 15% by weight of mannitol,
wherein the percentages by weight relate to the total amount of the sugars and sugar alcohols of the aqueous solution,
in the form of a 40% by weight to 90% by weight, preferably 70% by weight to 80% by weight, aqueous solution, wherein the percentages by weight cite the amount of dry matter, based on the total aqueous solution,
A1) adjusting the pH in such a manner that the aqueous solution has a pH of 4.0 to 5.0, preferably 4.1 to 4.5, particularly preferably 4.2 to 4.3, at a temperature of 25° C.,
B) heating the aqueous solution and reducing the water content to less than 2% by weight, preferably less than 1.5% by weight, in particular less than 0.5% by weight, based on the total aqueous solution,
C) cooling to a temperature of 100° C. to 130° C., in particular 110° C. to 120° C., and optionally adding further additives such as, for example, flavours, colours and acids, and optionally homogenizing, and
D) shaping and further cooling to give the desired hard sweet.

The aqueous solutions used in the second process according to the invention preferably contain, preferably consist of
20% by weight to 75% by weight, preferably 40% by weight to 65% by weight, particularly preferably 45% by weight to 60% by weight, of 6-O-α-D-glucopyranosyl-D-sorbitol,
25% by weight to 80% by weight, preferably 35% by weight to 60% by weight, particularly preferably 40% by weight to 55% by weight, of 1-O-α-D-glucopyranosyl-D-mannitol, optionally
0.02% by weight to 15% by weight, preferably 0.1% by weight to 10% by weight, particularly preferably 0.2% by weight to 5% by weight, of 1-O-α-D-glucopyranosyl-D-sorbitol, optionally
0.02% by weight to 15% by weight, preferably 0.1% by weight to 8% by weight, particularly preferably 0.2% by weight to 3.5% by weight, of sorbitol and optionally
0.02% by weight to 15% by weight, preferably 0.1% by weight to 10% by weight, particularly preferably 0.2% by weight to 2.9% by weight, of mannitol,
wherein the percentages by weight relate to the total amount of the sugars and sugar alcohols of the aqueous solution.

This second process according to the invention corresponds to the first process according to the invention, but in this second process, the pH is not primarily determined by usage of the mixed composition, but is monitored online in the running process via a titration in process step A1). Preferred embodiments of the second process according to the invention correspond to those of the first process according to the invention.

The present invention further relates to a third process for producing a hard sweet, comprising the process steps
A) providing a solid mixed composition according to the invention,
B) fusing the mixed composition,
C) cooling the mixed composition to a temperature of 120° C. to 150° C., in particular 130° C. to 140° C., and optionally adding further additives such as, for example, flavours, colours and acids, and optionally homogenizing and
D) shaping and further cooling the mixed composition to give the desired hard sweet.

This third process according to the invention corresponds to an injection-moulding process of the first process according to the invention in which the solid mixed composition according to the invention is used.

This process likewise profits from the advantageous properties of the pH buffering of isomalt. Solid mixed compositions according to the invention used in the third process according to the invention correspond to the preferred solid mixed compositions of the present invention.

The present invention further relates to a hard sweet containing a mixed composition according to the invention.

Likewise, hard sweets which are obtainable by one of the processes according to the invention are claimed.

The present invention is described by way of example in the examples listed below without any intention of limiting the invention, the scope of application of which arises from the entire description and the claims, to the embodiments specified in the examples.

The following figures are a component of the examples:

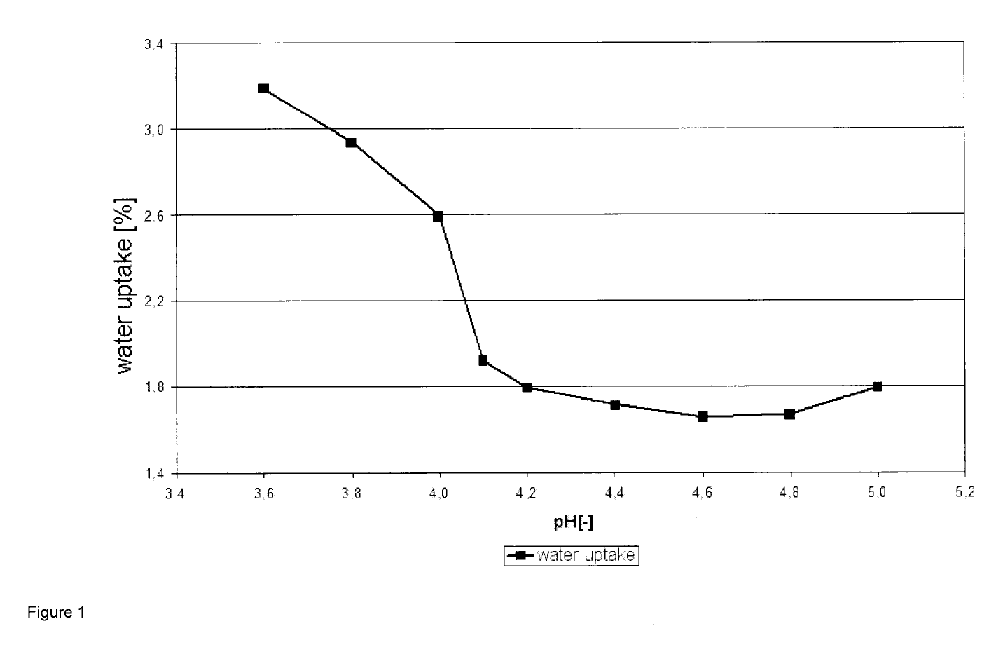

FIG. 1: Diagram of the water uptake of the sweet articles in percent by weight as a function of the pH of the initial solution of isomalt

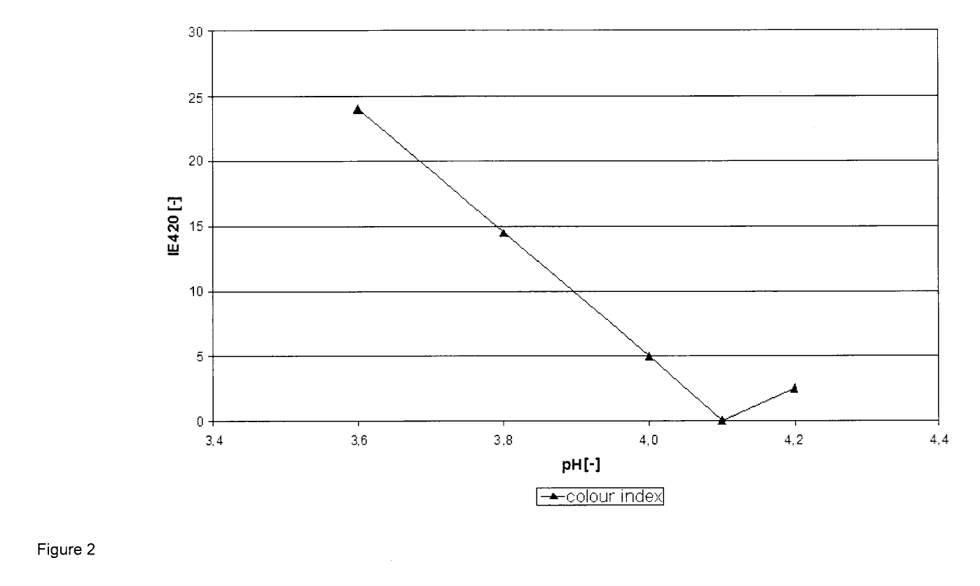

FIG. 2: Diagram of the ICUMSA colour index 1E420 of the sweet articles as a function of the pH of the initial solution of isomalt

### EXAMPLES

### Example 1 (Not According to the Invention): Determination of pH and Buffering Capacity of Commercial Isomalt

40 g of commercial isomalt (Isomalt ST, SUdzucker AG) were dissolved with constant stirring in 60 g of demineralized water by incubation at 80° C. for 30 min. The solution was cooled to 25° C. and the pH determined by using a pH glass electrode which had previously been calibrated using standard buffers pH 4.01 and pH 7.00. Proceeding from this solution, by means of automated titration processes by addition of 0.01 N NaOH to give a pH of 7.0 to give a defined volume of isomalt solution, the buffering capacity was determined on the basis of the amount of alkali consumed at a defined point. The following values were determined in this case:

| | |
|---|---|
| pH | 3.9 |
| Buffering capacity pH 5 | 0.1 mmol/l |

### Example 2: Sweets According to the Invention Having a Reduced Water Uptake by Adjustment of the pH

For production of the hard sweets, 40 g of commercial isomalt (Isomaltidex, Cargill) were dissolved in 60 g of demineralized water as described in Example 1.

By adding defined volumes of 1 N NaOH (aq), the pH of the solution was elevated stepwise up to a pH of 5.0, or by adding 1 N HCl (aq), was lowered stepwise to a defined value, down to a pH of 3.6.

The resultant solutions were heated in a glass beaker in an oil bath at 170° C.-180° C., with constant stirring on a magnetic stirrer. The temperature was monitored by means of a rod thermometer in the isomalt solution. After complete evaporation of the water fraction at 100° C.-105° C., the melt was further heated until a temperature of 165° C. was reached. The glass beaker was then allowed to cool at room temperature to 130° C.-135° C.

For evaluation of the water uptake of the material, sweet items were cast into Petri dishes (Ø3.5 cm) and allowed to cool at room temperature until solidification. Storage proceeded for 5 days at 25° C. and 80% relative humidity. The water uptake was evaluated on the basis of the weight gain of the sweet items.

Surprisingly, at a pH of 4.0, the result was an abrupt relative decrease in weight gain and therefore of hygroscopicity (see FIG. 1).

### Example 3: Sweets According to the Invention Having an Improved Colour Stability by Adjusting the pH

As described in Example 2, proceeding from commercial isomalt, by adding 1 N NaOH or 1 N HCl, above defined pHs were established and sweets produced.

For determining the colour index according to ICUMSA, a 10% by weight solution was produced in demineralized water by dissolution of 90 g of water and 10 g of melt.

In this case, an optimum of the colour index was found, and thereby of the transparency of the sweets at a pH of 4.1 to 4.2 (see FIG. 2).

1. An aqueous solution comprising water and
from 20% by weight to 75% by weight of 6-O-α-D-glucopyranosyl-D-sorbitol, and
from 25% by weight to 80% by weight of 1-O-α-D-glucopyranosyl-D-mannitol,
wherein the percentages by weight relate to the total amount of sugars and sugar alcohols in the total solution,
and wherein the aqueous solution, at a temperature of 25° C., has a pH of from 4.0 to 5.0.

2. The aqueous solution according to claim 1 further comprising
from 0.02% by weight to 15% by weight of α-D-glucopyranosyl-1,1-D-sorbitol,
optionally from 0.02% by weight to 15% by weight of sorbitol and
optionally from 0.02% by weight to 15% by weight of mannitol,
wherein the percentages by weight relate to the total amount of sugars and sugar alcohols in the total solution.

3. The aqueous solution according to claim 1 wherein the solution comprises a total amount of sugars and sugar alcohols of from 40% by weight to 90% by weight, based on the total aqueous solution.

4. A mixed composition comprising containing
from 20% by weight to 75% by weight of a-D-glucopyranosyl-1,6-D-sorbitol,
from 20% by weight to 75% by weight of a-D-glucopyranosyl-1,1-D-mannitol and
from 0.02% by weight to 15% by weight of a pH buffer substance,
wherein the percentages by weight relate to the total amount of [[the]] sugars and sugar alcohols in the total mixed composition,
wherein it has, in the form of a 40% by weight dry matter-containing aqueous solution, wherein the percentages by weight relate to the total aqueous solution, at a temperature of 25° C., a pH of from 4.0 to 5.0.

5. A mixed composition according to claim 4 further comprising
from 0.02% by weight to 15% by weight of α-D-glucopyranosyl-1,1-D-sorbitol,
optionally from 0.02% by weight to 15% by weight of sorbitol and
optionally from 0.02% by weight to 15% by weight of mannitol,
wherein the percentages by weight relate to the total amount of sugars and sugar alcohols in the total mixed composition.

6. The mixed Mixed composition according to claim 4
wherein it has, in the form of a 40% by weight dry matter-containing aqueous solution, wherein the percentages by weight relate to the total aqueous solution, at a temperature of 25° C. and a pH of 4.2, a buffering capacity of at least 0.01 mmol/l.

7. The mixed composition according to claim 4
wherein the pH buffer substance comprises at least one of citrate buffer, acetate buffer, and citrate-phosphate buffer.

8. The mixed composition according to claim 4
wherein the pH buffer substance is an acetate buffer comprising 0.12% by weight of glacial acetic acid and 0.08% by weight of sodium acetate trihydrate, wherein the percentages by weight relate to the dry matter of the total mixed composition, or
a citrate buffer comprising 0.30% by weight of citric acid and 0.31% by weight of sodium citrate, wherein the percentages by weight relate to the dry matter of the total mixed composition.

9. The mixed composition according to claim 4
wherein it is solid, at 25° C.

10. The mixed composition according to claim 8
wherein it has a water content of less than 2% by weight, based on the total mixed composition.

11. The mixed composition according to claim 4 in the form of an aqueous solution comprising water and from 40% by weight to 90% by weight of dry matter, based on the total aqueous solution.

12. The mixed composition according to claim 11 having a pH of from 4.0 to 5.0 at a temperature of 25° C.

13. A method for making a hard sweet, said method comprising
preparing the hard sweet from the aqueous solution of claim 1

14. A method for producing a hard sweet, said method comprising
A) heating the aqueous mixed composition of claim 11 and reducing the water content to less than 2% by weight, based on the total mixed composition,
B) cooling the water-reduced mixed composition from A to a temperature of from 100° C. to 120° C., and optionally adding further additives and optionally homogenizing, and
C) shaping the cooled mixed composition from B to give the hard sweet.

15. A method for producing a hard sweet, said method comprising
A) preparing the aqueous solution of claim 1 such that it comprises from 40% by weight to 90% by weight of dry matter, based on the total aqueous solution,
A1) adjusting the pH of the aqueous solution of A such that it has a pH of from 4.0 to 5.0 at a temperature of 25° C.,
B) heating the aqueous solution of A1 and reducing the water content to less than 2% by weight, based on the total mixed composition,
C) cooling the water-reduced product of B to a temperature of 100° C. to 120° C., and optionally adding further additives and optionally homogenizing to give a product, and
D) shaping the product of C to give the hard sweet.

16. A method for producing a hard sweet, said method comprising
A) fusing the mixed composition of claim 9,
B) cooling the fused mixed composition of A to a temperature of from 100° C. to 120° C., and optionally adding further additives and optionally homogenizing, and
C) shaping the cooled fused mixed composition of B to give the hard sweet.

17. A hard sweet obtained by the method of claim 14.

18. A hard sweet comprising the mixed composition of claim 4.

19. The aqueous solution of claim 1 wherein the pH is from 4.2 to 4.3 at a temperature of 25° C.

20. The mixed composition of claim 4 wherein the pH is from 4.2 to 4.3 at a temperature of 25° C.
